(19) United States
(12) Patent Application Publication
(10) Pub. No.: US 2024/0202870 A1
(43) Pub. Date: Jun. 20, 2024

(54) SUPER RESOLUTION IMAGE GENERATING DEVICE AND ASSOCIATED METHOD

(71) Applicant: Realtek Semiconductor Corp., HsinChu (TW)

(72) Inventors: Yi-Ting Bao, HsinChu (TW); Shang-Yen Lin, HsinChu (TW); Tien-Hung Lin, HsinChu (TW); Chia-Wei Yu, HsinChu (TW)

(73) Assignee: Realtek Semiconductor Corp., HsinChu (TW)

(21) Appl. No.: 18/381,649

(22) Filed: Oct. 19, 2023

(30) Foreign Application Priority Data
Dec. 14, 2022 (TW) 111148014

(51) Int. Cl. G06T 3/40; G06T 5/50

(52) U.S. Cl. CPC G06T 3/4053; G06T 5/50; G06T 2207/20132; G06T 2207/20221

(57) ABSTRACT

A super resolution (SR) image generating device includes a receiving circuit, a first configurable basic block pool circuit, a first shuffle circuit, a second configurable basic block pool circuit, and a second shuffle circuit. The receiving circuit is arranged to receive an input image. The first configurable basic block pool circuit is arranged to configure multiple first basic blocks according to the input image for performing convolution operations, to generate multiple first operation results. The first shuffle circuit is arranged to shuffle the multiple first operation results to generate a first SR output image. The second configurable basic block pool circuit is arranged to configure multiple second basic blocks according to the input image for performing convolution operations, to generate multiple second operation results. The second shuffle circuit is arranged to shuffle the multiple second operation results to generate a second SR output image.

### BACKGROUND OF THE INVENTION

### 1. Field of the Invention

The present invention is related to super resolution (SR) image processing, and more particularly, to an SR image generating device with multi-magnification and multi-output, and an associated SR image generating method.

### 2. Description of the Prior Art

In conventional SR technology, there is mainly a one-to-one mapping relationship between input and output, meaning that, after a conventional SR model receives an input image, only a single SR output image will be generated through SR image processing. This architecture may suffer from some problems, however. For example, when a user needs to simultaneously display the single SR output image to devices supporting different resolutions, an additional circuit (e.g. a scaling-up circuit or a scaling-down circuit) may be required to scale-up or scale-down the single SR output image for generating images with different resolutions, which may cause delays and/or sacrifice image quality.

In another example, the input image includes a main image and unimportant background images. If further SR processing needs to be performed upon the main image, the conventional SR model needs to perform the SR processing upon the entire input image, which may decrease the performance. In another example, when the input image is not a native image, operations may be performed to extract unimportant features, which may reduce the operation efficiency.

As a result, a novel SR image generating device with multi-magnification and multi-output and an associated SR image generating method are urgently needed.

### SUMMARY OF THE INVENTION

It is therefore one of the objectives of the present invention to provide an SR image generating device with multi-magnification and multi-output and an associated SR image generating method, to address the above-mentioned issues.

According to an embodiment of the present invention, an SR image generating device is provided. The SR image generating device comprises a receiving circuit, a first configurable basic block pool circuit, a first shuffle circuit, a second configurable basic block pool circuit, and a second shuffle circuit. The receiving circuit is arranged to receive an input image. The first configurable basic block pool circuit is arranged to configure multiple first basic blocks according to the input image for performing convolution operations, to generate multiple first operation results. The first shuffle circuit is arranged to shuffle the multiple first operation results to generate a first SR output image. The second configurable basic block pool circuit is arranged to configure multiple second basic blocks according to the input image for performing convolution operations, to generate multiple second operation results. The second shuffle circuit is arranged to shuffle the multiple second operation results to generate a second SR output image.

According to an embodiment of the present invention, an SR image generating method is provided. The SR image generating method comprises: receiving an input image; configuring multiple first basic blocks according to the input image for performing convolution operations in order to generate multiple first operation results; shuffling the multiple first operation results to generate a first SR output image; configuring multiple second basic blocks according to the input image for performing convolution operations in order to generate multiple second operation results; and shuffling the multiple second operation results to generate a second SR output image.

One of the benefits of the SR image generating device with multi-magnification and multi-output and the associated SR image generating method of the present invention is that the user's requirement for simultaneously transmitting an SR processed image to devices supporting different resolutions can be met without causing delay and/or sacrificing image quality. In addition, in some cases, an input image may include a main image that needs to be further processed by more convolution operations. The SR image generating device of the present invention can crop the main image from the input image by using a cropping circuit so that additional convolution operations are performed upon the main image only, which can increase the efficiency and the performance of the SR image processing. In some cases, the input image may not be a native image. The SR image generating device of the present invention can sample the input image by using a sampling circuit to generate a sampled image for performing convolution operations, which can increase the convolution operation efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an SR image generating device according to a first embodiment of the present invention.

FIG. 2 is a diagram illustrating an SR image generating device according to a second embodiment of the present invention.

FIG. 3 is a diagram illustrating an SR image generating device according to a third embodiment of the present invention.

FIG. 4 is a diagram illustrating an SR image generating device according to a fourth embodiment of the present invention.

FIG. 5 is a flow chart of an SR image generating method according to an embodiment of the present invention.

### DETAILED DESCRIPTION

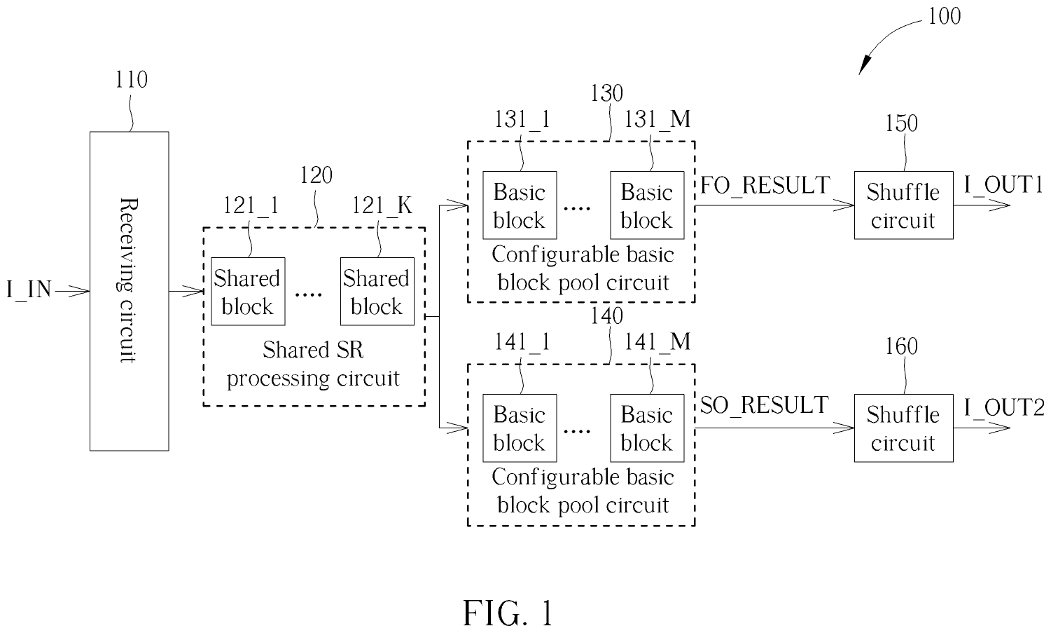

FIG. 1 is a diagram illustrating a super resolution (SR) image generating device 100 according to a first embodiment of the present invention. As shown in FIG. 1, the SR image generating device 100 may include a receiving circuit 110, multiple configurable basic block pool circuits 130 and 140, and multiple shuffle circuits 150 and 160. The receiving circuit 110 may be arranged to receive an input image I_IN. The configurable basic block pool circuits 130 and 140 may include a plurality of basic blocks 130_1-130_M (M≥1) and 140_1-140_N (N≥1), respectively, wherein the basic blocks 130_1-130_M and 140_1-140_N may be convolution blocks, residual network (ResNet) blocks, densely connected convolutional network (DenseNet) blocks, or other blocks based on convolutional neural network (CNN) architecture. In addition, both of the basic blocks 130_1-130_M and 140_1-140_N may be configured according to a depth requirement and/or a channel requirement regarding the color encoding format, respectively, for a stable delta value that can improve resolution and/or a generative adversarial network (GAN) delta value with details not present in the input image I_IN. Since the operations regarding basic block configuration are not the focus of the present invention, further descriptions are omitted here for brevity.

In this embodiment, the SR image generating device 100 may further include an optional shared SR processing circuit 120, wherein the configurable basic block pool circuit 130 may configure a part of the basic blocks 130_1-130_M to the shared SR processing circuit 120 to act as a plurality of shared basic blocks 121_1-121_K, and the configurable basic block pool circuit 140 may configure a part of the basic blocks 140_1-140_N to the shared SR processing circuit 120 to act as the shared basic blocks 121_1-121_K.

The configurable basic block pool circuit 130 may be arranged to perform convolution operations according to the input image I_IN to generate multiple operation results FO_RESULT. The shuffle circuit 150 may be arranged to shuffle the operation results FO_RESULT to generate an SR output image I_OUT1 with a ratio of ratio_1 to the input image I_IN. The configurable basic block pool circuit 140 may be arranged to perform convolution operations according to the input image I_IN to generate multiple operation results SO_RESULT. The shuffle circuit 160 may be arranged to shuffle the operation results SO_RESULT to generate an SR output image I_OUT2 with a ratio of ratio_2 to the input image I_IN. It should be noted that there does not need to be a specific multiple relationship between ratio_1 and ratio_2. For example, under a condition that the resolution of the input image I_IN is 720P, the resolutions of the SR output images I_OUT1 and I_OUT2 may be “4K and 2K” or “4K and 720P”. In addition, ratio_1 and ratio_2 may also be fractions less than 1; that is, the resolutions of the SR output images I_OUT1 and I_OUT2 may be smaller than that of the input image I_IN.

The number of basic operation units in the basic blocks 130_1-130_M and 140_1-140_N may vary according to design requirements. For example, under a condition that the resolution of the SR output image I_OUT1 is smaller than that of the SR output image I_OUT2, the number of basic operation units in the basic blocks 130_1-130_M may be smaller than those in the basic blocks 140_1-140_N, thereby saving costs. Under the above-mentioned condition, the number of basic operation units in the basic blocks 130_1-130_M may also be larger than or equal to those in the basic blocks 140_1-140_N, thereby achieving a better SR processing effect.

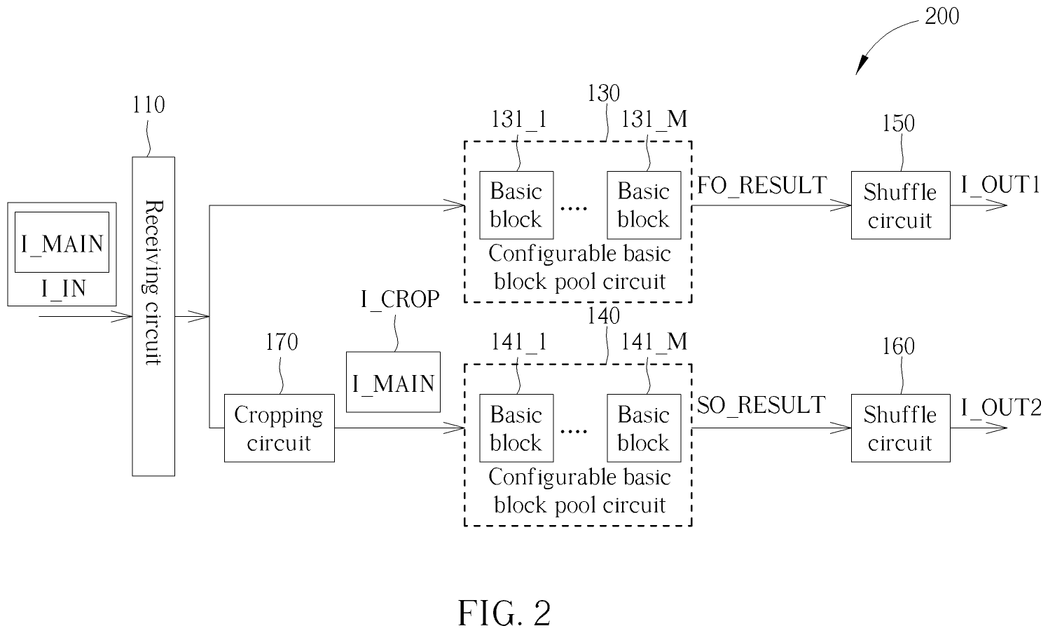

In some embodiments, the input image I_IN may include an image that needs to be additionally processed by more convolution operations. The SR image generating device 100 may crop the image from the input image I_IN to perform additional convolution operations. FIG. 2 is a diagram illustrating an SR image generating device 200 according to a second embodiment of the present invention. Compared with the SR image generating device 100 shown in FIG. 1, the SR image generating device 200 may further include a cropping circuit 170, wherein the input image I_IN may include a main image I_MAIN that needs to be additionally processed by more convolution operations. The cropping circuit 170 may be arranged to receive the input image I_IN from the receiving circuit 110, and crop the main image I_MAIN from the input image I_IN to act as a cropped image I_CROP. In this embodiment, the configurable basic block pool circuit 130 may be arranged to configure the basic blocks 130_1-130_M according to the complete input image I_IN for performing convolution operations in order to generate the operation results FO_RESULT. The shuffle circuit 150 may be arranged to shuffle the operation results FO_RESULT to generate the SR output image I_OUT1. The configurable basic block pool circuit 140 may be arranged to configure the basic blocks 140_1-140_N according to the cropped image I_CROP for performing additional convolution operations in order to generate the operation results SO_RESULT. The shuffle circuit 160 may be arranged to shuffle the operation results SO_RESULT to generate the SR output image I_OUT2.

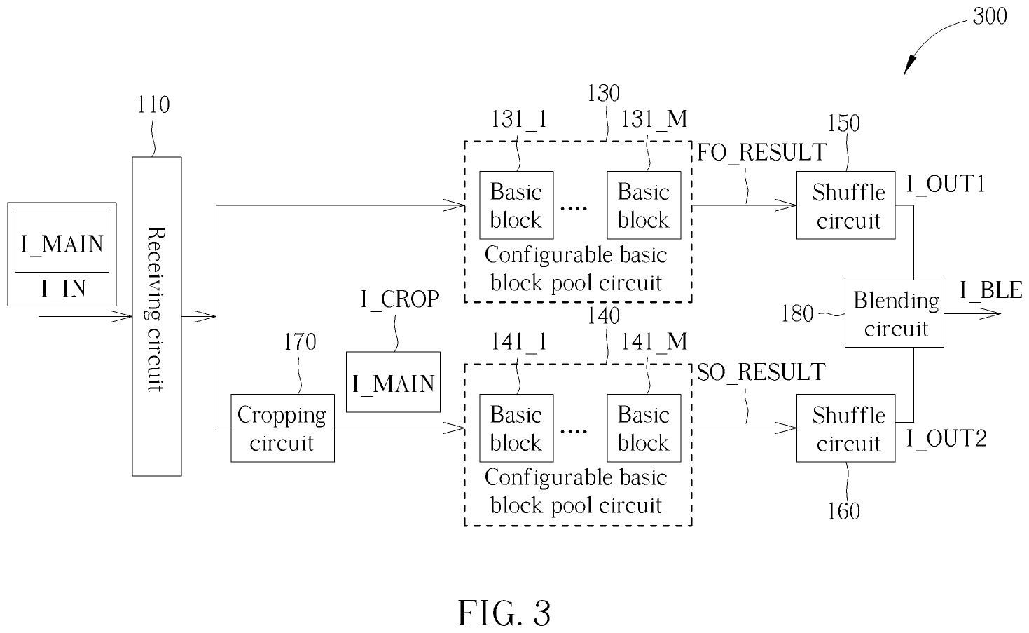

In some embodiments, the SR image generating device 100 may perform post-processing upon the SR image output images I_OUT1 and I_OUT2 to generate a single SR output image. FIG. 3 is a diagram illustrating an SR image generating device 300 according to a third embodiment of the present invention. Compared with the SR image generating device 200 shown in FIG. 2, the SR image generating device 300 may further include a blending circuit 180, wherein the blending circuit 180 may be arranged to blend the SR image output images I_OUT1 and I_OUT2 to generate a blended SR output image I_BLE. Since a person skilled in the pertinent art can readily understand operations of other circuits (i.e. the receiving circuit 110, the configurable basic block pool circuits 130 and 140, the shuffle circuits 150 and 160, and the cropping circuit 170) in FIG. 3 after reading the above paragraphs of FIG. 1 and FIG. 2, further descriptions are omitted here for brevity.

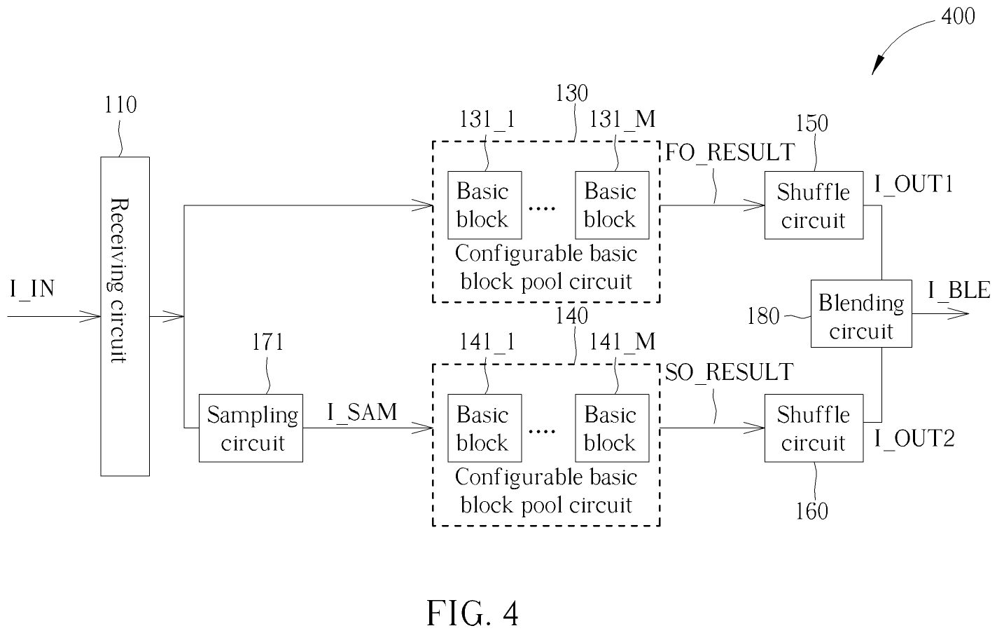

In some embodiments, the input image I_IN may not be a native image, and operations may be performed to extract unimportant features by the SR image generating device 100, which may decrease operation efficiency. To address this issue, the SR image generating device may sample the input image I_IN to generate a sampled image for performing convolution operations. FIG. 4 is a diagram illustrating an SR image generating device 400 according to a fourth embodiment of the present invention. Compared with the SR image generating device 100 shown in FIG. 1, the SR image generating device 400 may further include a sampling circuit 171. The sampling circuit 171 may be arranged to perform a sampling operation upon the input image I_IN to generate a sampled image I_SAM, wherein the sampling operation may be a pixel-drop operation, a filtered-based down-sampling operation, a machine-learning based feature extraction operation, or an AI-based sampling operation. The present invention is not limited thereto, however. Any sampling operation involving reduction of the data amount of the input image I_IN will fall within the scope of the present invention.

In this embodiment, the configurable basic block pool circuit 130 may be arranged to configure the basic blocks 130_1-130_M according to the complete input image I_IN for performing convolution operations in order to generate the operation results FO_RESULT. The shuffle circuit 150 may be arranged to shuffle the operation results FO_RESULT to generate the SR output image I_OUT1. The configurable basic block pool circuit 140 may be arranged to configure the basic blocks 140_1-140_N according to the sampled image I_SAM for performing convolution operations in order to generate the operation results SO_RESULT. The shuffle circuit 160 may be arranged to shuffle the operation results SO_RESULT to generate the SR output image I_OUT2. In addition, compared with the SR image generating device 100 shown in FIG. 1, the SR image generating device 400 may further include a blending circuit 180. The blending circuit 180 may be arranged to blend the SR image output images I_OUT1 and I_OUT2 to generate the blended SR output image I_BLE. For brevity, similar descriptions for this embodiment are not repeated in detail here.

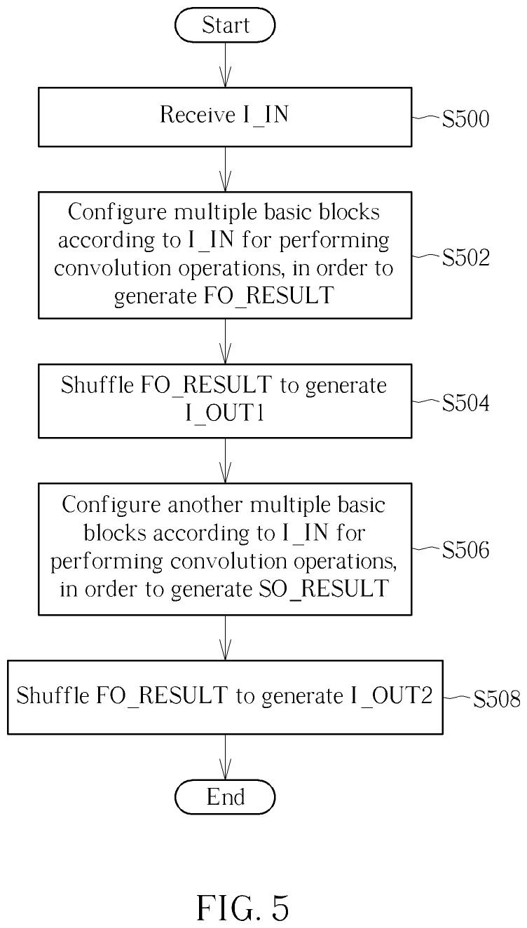

FIG. 5 is a flow chart of an SR image generating method according to an embodiment of the present invention. Provided that the result is substantially the same, the steps are not required to be executed in the exact order shown in FIG. 5. For example, the SR image generating method shown in FIG. 5 may be employed by the SR image generating devices 100, 200, 300, and 400.

In Step S500, the input image I_IN is received by the receiving circuit 110.

In Step S502, the basic blocks 131 1-131 M are configured by the configurable basic block pool circuit 130 according to the input image I_IN for performing convolution operations in order to generate the operation results FO_RESULT.

In Step S504, the operation results FO_RESULT are shuffled by the shuffle circuit 150 to generate the SR image output image I_OUT1.

In Step S506, the basic blocks 141_1-141_N are configured by the configurable basic block pool circuit 140 according to the input image I_IN for performing convolution operations in order to generate the operation results SO_RESULT.

In Step S508, the operation results SO_RESULT are shuffled by the shuffle circuit 160 to generate the SR image output image I_OUT2.

Since a person skilled in the pertinent art can readily understand details of the steps shown in FIG. 5 after reading the above paragraphs directed to the SR image generating devices 100, 200, 300, and 400, further descriptions are omitted here for brevity.

In summary, by using the SR image generating devices 100, 200, 300, and 400 with multi-magnification and multi-output and the associated SR image generating method, the user's requirement for simultaneously transmitting an SR processed image to devices supporting different resolutions can be met without causing delay and/or sacrificing image quality. In addition, in some cases, the input image I_IN may include the main image I_MAIN that needs to be further processed by more convolution operations. The SR image generating devices 200 and 300 can crop the main image I_MAIN from the input image I_IN and perform additional convolution operations upon the main image I_MAIN only, which can increase the efficiency and the performance of the SR image processing. In some cases, the input image I_IN may not be a native image. The SR image generating device 400 can sample the input image I_IN to generate the sampled image I_SAM for performing convolution operations, which can increase the convolution operation efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A super resolution (SR) image generating device, comprising:
a receiving circuit, arranged to receive an input image;
a first configurable basic block pool circuit, arranged to configure multiple first basic blocks according to the input image for performing convolution operations, to generate multiple first operation results;
a first shuffle circuit, arranged to shuffle the multiple first operation results to generate a first SR output image;
a second configurable basic block pool circuit, arranged to configure multiple second basic blocks according to the input image for performing convolution operations, to generate multiple second operation results; and
a second shuffle circuit, arranged to shuffle the multiple second operation results to generate a second SR output image.

2. The SR image generating device of claim 1, wherein the SR image generating device further comprises a shared SR processing circuit, the first configurable basic block pool circuit configures a portion of the multiple first basic blocks to the shared SR processing circuit as multiple shared basic blocks, and the second configurable basic block pool circuit configures a portion of the multiple second basic blocks to the shared SR processing circuit as the multiple shared basic blocks.

3. The SR image generating device of claim 1, further comprising:
a cropping circuit, arranged to crop the input image to generate a cropped image;
wherein the second configurable basic block pool circuit is arranged to configure the multiple second basic blocks according to the cropped image for performing convolution operations, to generate the multiple second operation results.

4. The SR image generating device of claim 1, further comprising:
a sampling circuit, arranged to sample the input image to generate a sampled image;
wherein the second configurable basic block pool circuit is arranged to configure the multiple second basic blocks according to the sampled image for performing convolution operations, to generate the multiple second operation results.

5. The SR image generating device of claim 1, further comprising:
a blending circuit, arranged to blend the first SR output image and the second SR output image to generate a blended SR output image.

6. A super resolution (SR) image generating method, comprising:
receiving an input image;
configuring multiple first basic blocks according to the input image for performing convolution operations, to generate multiple first operation results;
shuffling the multiple first operation results to generate a first SR output image;
configuring multiple second basic blocks according to the input image for performing convolution operations, to generate multiple second operation results; and
shuffling the multiple second operation results to generate a second SR output image.

7. The SR image generating method of claim 6, further comprising:
configuring a portion of the multiple first basic blocks to a shared SR processing circuit as multiple shared basic blocks; and
configuring a portion of the multiple second basic blocks to the shared SR processing circuit as the multiple shared basic blocks.

8. The SR image generating method of claim 6, wherein the step of configuring the multiple second basic blocks according to the input image for performing convolution operations, to generate the multiple second operation results comprises:
cropping the input image to generate a cropped image; and
configuring the multiple second basic blocks according to the cropped image for performing convolution operations, to generate the multiple second operation results.

9. The SR image generating method of claim 6, wherein the step of configuring the multiple second basic blocks according to the input image for performing convolution operations, to generate the multiple second operation results comprises:
sampling the input image to generate a sampled image; and
configuring the multiple second basic blocks according to the sampled image for performing convolution operations, to generate the multiple second operation results.

10. The SR image generating method of claim 6, further comprising:
blending the first SR output image and the second SR output image to generate a blended SR output image.
